(19) United States
(12) Patent Application Publication
(10) Pub. No.: US 2015/0176895 A1
(43) Pub. Date: Jun. 25, 2015

(54) METHOD OF DRYING TRANSPORT/STORAGE CONTAINERS FOR RADIOACTIVE WASTE

(71) Applicants: Astrid JUSSOFIE, Essen (DE); Christoph RIRSCHL, Herne (DE); Volker ENDER, Bertsdorf-Hoernitz (DE)

(72) Inventors: Astrid JUSSOFIE, Essen (DE); Christoph RIRSCHL, Herne (DE); Volker ENDER, Bertsdorf-Hoernitz (DE)

(21) Appl. No.: 14/575,785

(22) Filed: Dec. 18, 2014

(30) Foreign Application Priority Data
Dec. 20, 2013 (EP) 13198998.8

(51) Int. Cl. F26B 5/04

(52) U.S. Cl. CPC F26B 5/04

(57) ABSTRACT

A method of drying a transport/storage container for radioactive waste where the container holds water at least some of which is chemically bound with a boron compound. The method has the steps of first adding to the water in the container a reagent that frees the boron compound from the chemically bound water, and then removing by vacuum drying the water in the container including the water that has been freed of the boron compound.

### FIELD OF THE INVENTION

The present invention relates to containers for the storage and/or transport of radioactive waste. More particularly this invention concerns a method of drying such containers.

### BACKGROUND OF THE INVENTION

Transport/storage containers for radioactive waste, especially for spent fuel elements, are typically internally dried, in particular by vacuum drying.

In use the containers are normally filled with water around the spent fuel elements because water provides an effective shield material for any neutrons that are generated. The water used in this context is called pool water. Especially in pressurized-water reactors (PWRs) the pool water is normally supplemented with a boron compound, usually in the form of boric acid. About 20% of natural boron is made of isotope B-10 that has a high absorption coefficient for thermal neutrons.

On re-use of the container, that is after removing the spent rods being stored or transported, it is customary to first drain the container by pouring or pumping out the water therein and subsequently to remove any water or pool water still remaining from the container by drying, in particular by vacuum drying. Vacuum drying is advantageously performed by applying a negative or subatmospheric pressure and in fact alternatively a subatmospheric pressure of at most 12 mbar, preferably at most 10 mbar. This subatmospheric pressure is applied to the container interior. It lies within the scope of the invention that the subatmospheric pressure is advantageously limited to 10 mbar, especially to prevent the residual water from freezing at 6 mbar.

Nevertheless, after such vacuum drying there is generally some water still left inside the container, in the form of water chemically bound to the boron compound and/or to boric acid formed thereby. This bound water makes it difficult to ascertain if the container is really dry, which must be done in light of the corrosive impact of residual water.

### OBJECTS OF THE INVENTION

It is therefore an object of the present invention to provide an improved method of drying transport\storage containers for radioactive waste.

Another object is the provision of such an improved method of drying transport\storage containers for radioactive waste that overcomes the above-given disadvantages, in particular that can be used to avoid the problem explained in the previous paragraph and to effectively remove residual water from the container interior.

### SUMMARY OF THE INVENTION

A method of drying a transport/storage container for radioactive waste where the container holds water at least some of which is chemically bound with a boron compound. The method has according to the invention the steps of sequentially:

adding to the water in the container a reagent that frees the boron compound from the chemically bound water, and

removing by vacuum drying the water in the container including the water that has been freed of the boron compound.

Thus the invention is based on the discovery that by using the claimed method not only is the unbound pool water removed when the drying process is carried out for the container interior, but also that the bound water is released and can be drained or removed. The at least one reagent introduced into the container interior reacts with the boron compound inside the container and this action releases the water bound to the boron compound. This released water can be removed from the container during the vacuum drying process.

Advantageously the boron compound with chemically bound water is boric acid or orthoboric acid (H₃BO₃). The boron compound or the boric acid serves as an absorbent for any occurring thermal neutrons. Advantageously the boron content in the water/pool water of the container equals 2000 to 3600 ppm, alternatively 2200 to 3400 ppm and preferably 2250 to 3200 ppm, for instance 2400 ppm.

The invention is based on the discovery that it is not possible to remove or vaporize the boric acid during the drying process because for structural reasons it is recommended to limit subatmospheric pressure inside the container to 10 mbar. Within the scope of the method according to the invention, the product water freed in the reaction between the boron compound and the reagent is extracted or vaporized from the container interior.

According to the preferred embodiment of the method according to the invention, the boron compound with chemically bound water and the reagent together form a vaporizable boron compound as a reaction product. Preferably this vaporizable boron compound or reaction product is removed or extracted from the container interior during the vacuum drying process. Hence, according to the preferred embodiment, not only is the water released from the boron compound but at the same time the vaporizable boron compound formed as a reaction product is removed or vaporized from the container interior.

It lies within the scope of the invention that at least one alcohol is introduced as a reagent into the container interior or placed in the container interior and that it forms boric acid ester. More specifically, the reaction of boric acid with alcohol forms boric acid ester and water as reaction products. It also lies within the scope of the invention that the vaporizable boric acid ester as well as water are both then extracted during the vacuum drying. At the same time the extraction of water from the inside of the container shifts the reaction equilibrium (ester formation) to the side of the formed ester and avoids or dilutes the hydrolysis of esters to the reagents.

It lies within the scope of the invention that an alcohol is used as the reagent to form an azeotrope or a zeotropic mixture with water. According to the preferred embodiment of the invention, an alcohol is used as a reagent that has a higher boiling point, especially one that is around at least 2° C., preferably around at least 3° C. higher than the corresponding azeotrope/zeotropic mixture of alcohol and water. It is especially preferred to use an alcohol as a reagent that has a boiling point that is at least 5° C., highly preferred at least 8° C. higher than the corresponding azeotrope from the alcohol and water. It lies within the scope of the invention that the released water is extracted as an azeotrope with the alcohol from the container interior. In so doing, the water is extracted from the reaction equilibrium (ester formation) and—as already illustrated above—this shifts the reaction equilibrium to the side of the formed ester and ester hydrolysis is avoided or diluted.

An especially preferred embodiment of the invention is is characterized in that a short-chain alcohol is used as a reagent, the alcohol preferably having a number of carbon atoms Cₙ with n≧2. At the same time an alcohol with a number of carbon atoms Cₙ with n=3 or n=4 is especially preferred. A highly recommended embodiment of the method according to the invention distinguishes itself in that propanol, in particular n-propanol (n=3), is used as a reagent. N-propanol has performed particularly well in the scope of the method according to the invention. A zeotropic mixture with water is made up of 71.1% n-propanol by weight or around 71.1% n-propanol by weight. Under normal conditions the boiling point of n-propanol is 97.2° C. and is thus advantageously around 10° C. higher than the boiling point of the zeotropic mixture made of water and n-propanol (87.7° C.) Comparable differences in temperature are also present under the conditions prevailing in the container or under the conditions of vacuum drying or low pressure drying.

Ethanol and especially methanol are less suited as reagents with the method according to the invention.

According to an especially preferred embodiment of the invention, the alcohol or the recommended n-propanol is added in excess such that the residual moisture including the split reaction water can be removed from the container interior under the given vacuum drying conditions—preferably with a maximum low pressure of 10 mbar. The required excess alcohol or n-propanol depends on the concentration of the boron compound or of the boric acid and from the quantity of water that is left in the container after the water has been drained from the container interior and before the vacuum drying. Alcohol or n-propanol can also be added to the container interior repeatedly.

It lies within the scope of the invention that the alcohol, in particular the n-propanol, is extracted or vaporized from the container interior in the course of vacuum drying. It is also within the scope of the invention that the reaction water split from the boron compound is first removed from the reaction equilibrium and that the alcohol or the n-propanol is subsequently extracted or vaporized.

An especially preferred embodiment of the method according to the invention is characterized in that the conversion (reaction) of the boron compound containing chemically bound water—in particular boric acid—with the reagent is carried out free of acid catalysts or essentially free of acid catalysts. This works advantageously without an acid and in particular without sulfuric acid as a catalyst. Hence, the invention is based on the discovery that it is possible to avoid the negative corrosive influences of such an acidic catalyst with respect to long-term corrosion resistance of the container.

The invention is also based on the discovery that by using the method according to the invention water residue and disadvantageous or troublesome residual moisture can be removed effectively and in a functionally safe manner from the interior of a transport/storage container for spent fuel elements. At the same time it is a particular advantage that the method can be conducted in such a way that even the reagents used in the reaction according to the invention, in particular an alcohol used as reagent, can be removed from the container interior. At the same time the method according to the invention is simple and can be performed with little effort and cost effectively. No expensive additional measures or additional components are required. After the method according to the invention has been carried out, any existing and no longer troublesome residual is moisture in the container interior can be precisely and reproducibly accounted for. The invention offers an effective and yet simple and inexpensive option for removing chemically bound water from the container interior of a transport/storage container for spent fuel elements.

We claim:

1. A method of drying a transport/storage container for radioactive waste where the container holds water at least some of which is chemically bound with a boron compound, the method comprising the steps of sequentially:
adding to the water in the container a reagent that frees the boron compound from the chemically bound water; and
removing by vacuum drying the water in the container including the water that has been freed of the boron compound.

2. The container-drying method defined in claim 1, wherein the vacuum drying is effected at a subatmospheric pressure of at most 12 mbar.

3. The container-drying method defined in claim 1, wherein the boron compound is boric or orthoboric acid.

4. The container-drying method defined in claim 1, wherein the boron compound with chemically bound water and the reagent together form a vaporizable boron product as a reaction product, the method further comprising the step of:
removing the vaporizable boron product as reaction product from the container during the vacuum drying.

5. The container-drying method defined in claim 1, wherein the reagent is at least one alcohol that forms with the boron compound a boric acid ester as reaction product.

6. The container-drying method defined in claim 1, wherein the reaction product is an alcohol having a boiling point that is at least 2° C. higher than an azeotrope formed by a mixture of the alcohol and water.

7. The container-drying method defined in claim 1 wherein the reaction product is an alcohol with a number of carbon atoms Cₙ where n=3 or 4.

8. The container-drying method defined in claim 7 wherein 3-propanol is the alcohol used as the reagent.

9. The container-drying method defined in claim 1, wherein the reaction product is an alcohol and an excess of the alcohol is added as the reagent.

10. The container-drying method defined in claim 1, wherein the reagent is alcohol that is extracted or vaporized from the container interior by the vacuum drying.

11. The container-drying method defined in claim 1, wherein the reaction of the reactive agent and the bound water is conducted without the use of acidic catalysts or essentially free of acidic catalysts.
